(19) United States
(12) Patent Application Publication
(10) Pub. No.: US 2009/0157727 A1
(43) Pub. Date: Jun. 18, 2009

(54) Method, Apparatus and Computer Program Product for Providing Native Broadcast Support for Hypermedia Formats and/or Widgets

(75) Inventor: Toni Paila, Stamford, CT (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/958,614

(22) Filed: Dec. 18, 2007

(51) Int. Cl. G06F 17/30; G06F 15/177

(52) U.S. Cl. 707/102; 709/220; 707/E17.117

(57) ABSTRACT

An apparatus for enabling the receipt of native broadcast content by browsers or web applications may include an active adapter. The active adapter may be configured to receive an indication of native signaling, generate an address accessible by a browser or web application, associate the address with corresponding native access parameters determined from the native signaling, and provide the address to a user to enable the browser or web application to render the native signaling via the association of the native access parameters in response to user selection of the address.

### TECHNOLOGICAL FIELD

Embodiments of the present invention generally relate to systems and methods for receiving broadcast content and, more particularly, to an apparatus, method and computer program product for enabling the receipt of native broadcast content by browsers or web applications.

### BACKGROUND OF THE INVENTION

The deployment of advanced high bit-rate networks has opened up new opportunities for delivering a host of services in a way that was not possible with earlier networks. Examples of such deliverable services that have shown promise include Digital Video Broadcasting (DVB) and internet protocol television (IPTV). In this regard, DVB-T (the terrestrial variant of the DVB standard), which is related to DVB-C (cable) DVB-S (satellite), and DVB-H (handheld), along with MediaFLO, Terrestrial Integrated Service Digital Broadcasting (ISDB-T), Terrestrial Digital Multimedia Broadcasting (T-DMB) and other broadcast mechanisms, represent native broadcast systems that deliver data such as unidirectional audio/visual broadcast streams to users. Content within the broadcast streams of these native broadcast mechanisms typically includes metadata and/or signaling that may enable discovery of the corresponding service by a web application or browser. However, the browser or web application is typically not able to access the content of the native broadcast without a special interface to access native broadcast drivers.

Recently, solutions have been developed in order to facilitate enablement of web applications or browsers to access native broadcast content. In this regard, solutions such as multimedia home platform (MHP), Java JSR-272 and others have been developed to enable the browser to run, for example, a Java or similar application to invoke special interfaces for providing access to native broadcast drivers. Accordingly, the current solutions utilize Java, BREW, or a similar application programming interface (API) description that can provide an interface to enable access to the native broadcast drivers via code authored in Java, BREW, etc. Thus, web pages, hypermedia documents and scripts, whether rendered and executed from a web browser or a web application such as a widget, may be enabled to access audio/video content streams over a native broadcast interface. Widgets are web applications that can run independently from the browser application. In other words, widgets are web pages that are normally designed for a specific purpose and which utilize standard-based Internet technologies such as Hypertext Markup Language (HTML), cascading style sheets (CSS), JavaScript and even asynchronous AJAX (JavaScript and extensible markup language (XML)). Some widgets (e.g., mobile widgets) are intended for use on mobile devices.

Despite the possibility of being enabled to access native broadcast content via the mechanisms described above, there are certain situations in which the mechanisms described above may not be optimal or desirable. For example, some browsers (e.g., certain legacy browsers) may not be able to support MHP classes or Java JSR-272. Accordingly, a lack of backward compatibility may be a concern in some instances. Additionally, MHP, Java JSR-272 or other implementations involving Java or similar mechanisms may be considered too substantial in terms of the size and/or resource consumption they require.

Accordingly, there may be a need to provide a mechanism by which at least some of the disadvantages described above may be overcome.

### SUMMARY OF THE INVENTION

In light of the foregoing background, exemplary embodiments of the present invention provide an improved apparatus, method and computer program product for enabling the receipt of native broadcast content by browsers or web applications. Specifically, exemplary embodiments of the present invention may enable receipt of native broadcast content in a manner that may overcome at least some of the disadvantages described above. In this regard, for example, an address (e.g., a uniform resource locator (URL) or local port) that a web application or browser can understand or otherwise handle may be generated for association with native access parameters that may enable the web application or browser to access the native broadcast without utilizing Java or other mechanisms that may not be lightweight implementations. Accordingly, embodiments of the present invention may allow a lighter weight implementation that may be more readily backward compatible than conventional mechanisms.

In one exemplary embodiment, a method of enabling the receipt of native broadcast content by browsers or web applications is provided. The method may include receiving an indication of native signaling, generating an address accessible by a browser or web application, associating the address with corresponding native access parameters determined from the native signaling, and providing the address to a browser and/or user to enable the browser or web application to render the native signaling via the association of the native access parameters in response to user selection of the address. The address type can be specific to the native signaling. For example, DVB-T, MPEG2-TS, etc., could have an address of one particular type and structure, while MediaFLO could have an address of another type and structure. However, this is not necessary, since all native signaling could result in the same type and structure in some embodiments.

In another exemplary embodiment, a computer program product for enabling the receipt of native broadcast content by browsers or web applications is provided. The computer program product includes at least one computer-readable storage medium having computer-readable program code portions stored therein. The computer-readable program code portions include first, second, third and fourth executable portions. The first executable portion is for receiving an indication of native signaling. The second executable portion is for generating an address accessible by a browser or web application. The third executable portion is for associating the address with corresponding native access parameters determined from the native signaling. The fourth executable portion is for providing the address to a user to enable the browser or web application to render the native signaling via the association of the native access parameters in response to user selection of the address.

In another exemplary embodiment, an apparatus for enabling the receipt of native broadcast content by browsers or web applications is provided. The apparatus may include an active adapter. The active adapter may be configured to receive an indication of native signaling, generate an address accessible by a browser or web application, associate the address with corresponding native access parameters determined from the native signaling, and provide the address to a user to enable the browser or web application to render the native signaling via the association of the native access parameters in response to user selection of the address.

In another exemplary embodiment, an apparatus for enabling the receipt of native broadcast content by browsers or web applications is provided. The apparatus includes means for receiving an indication of native signaling, means for generating an address accessible by a browser or web application, means for associating the address with corresponding native access parameters determined from the native signaling, and means for providing the address to a user to enable the browser or web application to render the native signaling via the association of the native access parameters in response to user selection of the address.

Additionally, in another exemplary embodiment, an apparatus for enabling the receipt of native broadcast content by browsers or web applications is provided. The apparatus includes means for receiving an indication of native signaling, means for identifying native type of content, means of generating/associating a trans-coder that can trans-code native content to a content format recognized by a web browser or one of its plug-ins, means for generating an address accessible by a browser or web application, means for associating the address with generated/associated trans-coder corresponding native access parameters determined from the native signaling, and means for providing the address to a user to enable the browser or web application to render the native signaling and content via the association of the native access parameters in response to user selection of the generated web address.

Embodiments of the invention may provide a method, apparatus and computer program product for employment, for example, in mobile or fixed terminal environments. As a result, for example, mobile and fixed terminal users may enjoy an improved capability of receiving native broadcast data.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for enabling the receipt of native broadcast content by browsers or web applications according to an exemplary embodiment of the present invention; and

FIG. 4 is a flowchart according to an exemplary method for enabling the receipt of native broadcast content by browsers or web applications according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

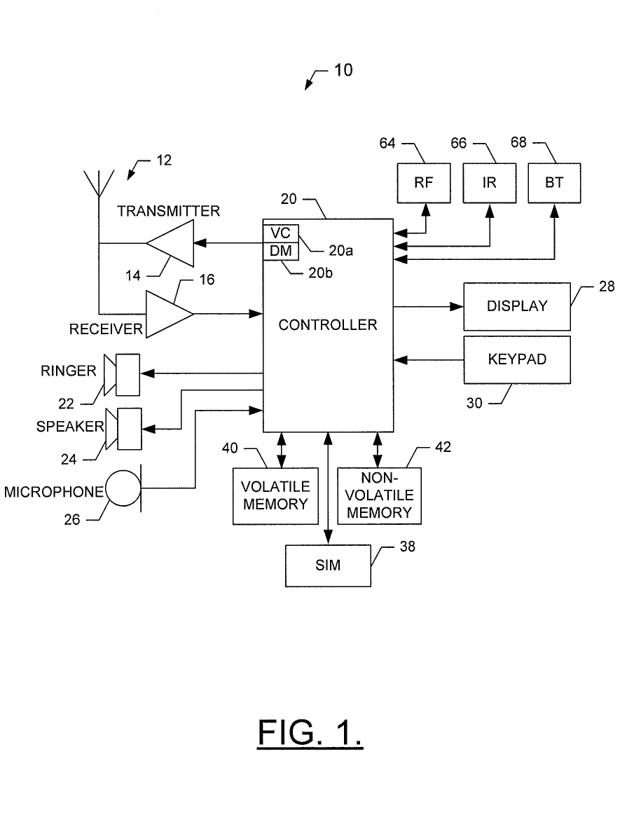

FIG. 1 illustrates a block diagram of a mobile terminal 10 that may benefit from the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ the present invention.

As shown, the mobile terminal 10 includes an antenna 12 in communication with a transmitter 14, and a receiver 16. The mobile terminal also includes a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as UMTS network employing WCDMA radio access technology. Some NAMPS, as well as TACS, mobile terminals may also benefit from the teaching of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 22a, an internal data modem (DM) 22b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

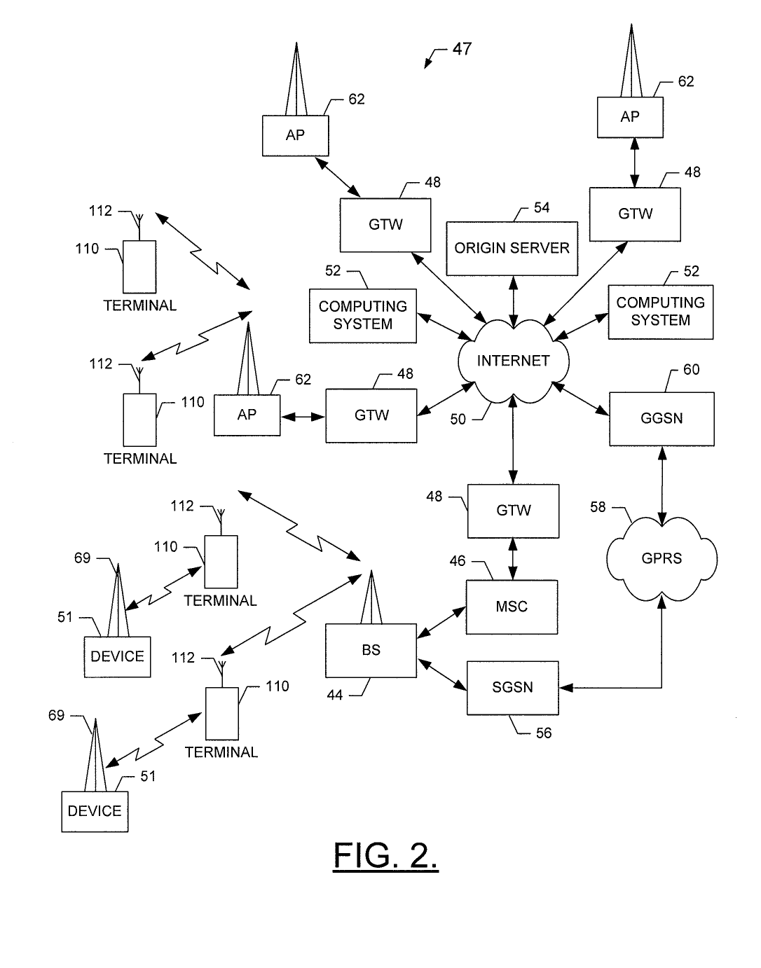

Referring now to FIG. 2, an illustration of one type of system that could support communications to and from an electronic device, such as the mobile terminal of FIG. 1, is provided by way of example, but not of limitation. As shown, one or more mobile terminals 110 may each include an antenna 112 for transmitting signals to and for receiving signals from a base site or base station (BS) 44. The base station 44 may be a part of one or more cellular or mobile networks each of which may comprise elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 110 when the mobile terminal 110 is making and receiving calls. The MSC 46 may also provide a connection to landline trunks when the mobile terminal 110 is involved in a call. In addition, the MSC 46 may be capable of controlling the forwarding of messages to and from the mobile terminal 110, and may also control the forwarding of messages for the mobile terminal 110 to and from a messaging center. It should be noted that although the MSC 46 is shown in the system of FIG. 2, the MSC 46 is merely an exemplary network device and the present invention is not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 110 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 110 to and from the messaging center.

In addition, by coupling the SGSN 56 to the GPRS core network 58 and the GGSN 60, devices such as a computing system 52 and/or origin server 54 may be coupled to the mobile terminal 110 via the Internet 50, SGSN 56 and GGSN 60. In this regard, devices such as the computing system 52 and/or origin server 54 may communicate with the mobile terminal 110 across the SGSN 56, GPRS core network 58 and the GGSN 60. By directly or indirectly connecting mobile terminals 110 and the other devices (e.g., computing system 52, origin server 54, etc.) to the Internet 50, the mobile terminals 110 may communicate with the other devices and with one another, such as according to the Hypertext Transfer Protocol (HTTP), to thereby carry out various functions of the mobile terminals 110.

Although not every element of every possible mobile network is shown in FIG. 2 and described herein, it should be appreciated that electronic devices, such as the mobile terminal 110, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 110 may further be coupled to one or more wireless access points (APs) 62. The APs 62 may comprise access points configured to communicate with the mobile terminal 110 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 110 and the computing system 52, the origin server 54, and/or any of a number of other devices, to the Internet 50, the mobile terminals 110 may communicate with one another, the computing system, etc., to thereby carry out various functions of the mobile terminals 110, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 110 to computing systems 52 and/or origin server 54 across the Internet 50, the mobile terminal 110, computing system 52 and origin server 54 may be coupled to one another and communicate in accordance with, for example, RF, BT, IrDA or any of a number of different wireline or wireless communication techniques, including LAN, WLAN, WiMAX, Wireless Fidelity (Wi-Fi), Wibree™ and/or UWB techniques. One or more of the computing systems 52 may additionally, or alternatively, include a removable memory capable of storing content, which can thereafter be transferred to the mobile terminal 110. Further, the mobile terminal 110 may be coupled to one or more electronic devices, such as printers, digital projectors and/or other multimedia capturing, producing and/or storing devices (e.g., other terminals). Like with the computing systems 52, the mobile terminal 110 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 110 may be capable of communicating with other devices via short-range communication techniques. For instance, the mobile terminal 110 may be in wireless short-range communication with one or more devices 51 that are equipped with a short-range communication transceiver 69. The electronic devices 51 can comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

In an exemplary embodiment, content or data may be communicated over the system of FIG. 2 between a mobile terminal, which may be similar to the mobile terminal 10 of FIG. 1 or mobile terminal 110 of FIG. 2, and a network device of the system of FIG. 2 in order to, for example, execute applications or establish communication (for example, for purposes of content sharing) between the mobile terminal 10 or 110 and other mobile terminals or between the mobile terminal 10 or 110 and a network device. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10 or 110, and/or may be resident on a camera, server, personal computer or other device, absent any communication with the system of FIG. 2.

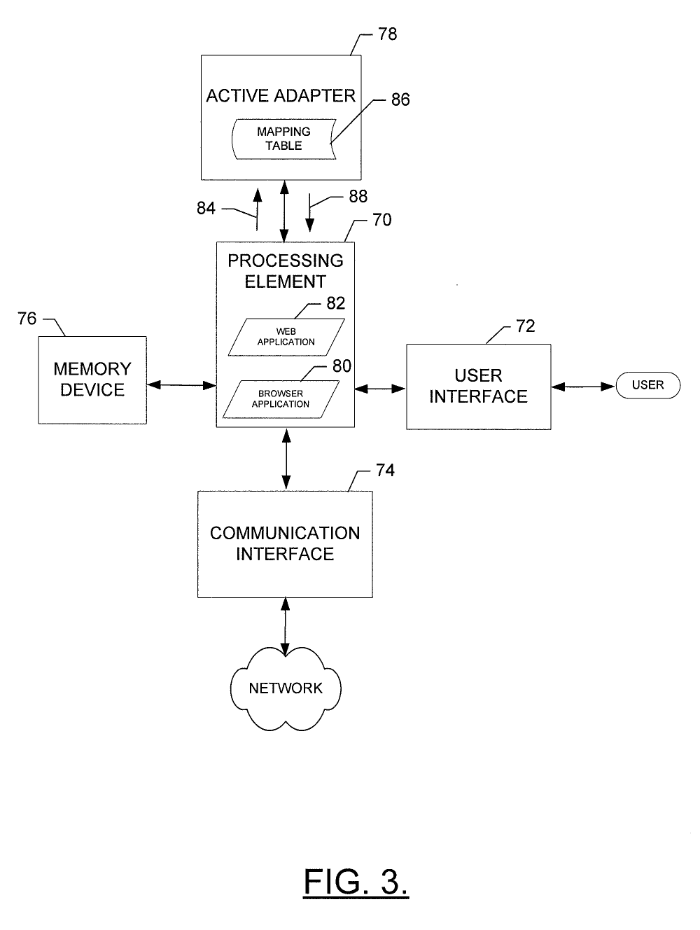

An exemplary embodiment of the invention will now be described with reference to FIG. 3, in which certain elements of an apparatus for enabling the receipt of native broadcast content by browsers or web applications are displayed. The apparatus of FIG. 3 may be embodied as or otherwise employed, for example, on the mobile terminal 10 of FIG. 1 or the mobile terminal 110 or a network device of FIG. 2. However, it should be noted that the system of FIG. 3, may also be employed on a variety of other devices, both mobile and fixed, and therefore, the present invention should not be limited to application on devices such as mobile terminals and/or network devices. It should also be noted that while FIG. 3 illustrates one example of a configuration of an apparatus for enabling the receipt of native broadcast content by browsers or web applications, numerous other configurations may also be used to implement embodiments of the present invention.

Referring now to FIG. 3, an apparatus for enabling the receipt of native broadcast content by browsers or web applications is provided. The apparatus may include or otherwise be in communication with a processing element 70 (e.g., controller 20), a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, one or more applications, instructions, and/or the like for enabling the apparatus to carry out various functions in accordance with exemplary embodiments of the present invention. For example, the memory device 76 could be configured to buffer input data for processing by the processing element 70. Additionally or alternatively, the memory device 76 may be configured to store instructions for execution by the processing element 70. As yet another alternative, the memory device 76 may be one of a plurality of databases that store information and/or media content, for example, in association with a particular location.

The processing element 70 may be embodied in a number of different ways. For example, the processing element 70 may be embodied as a processor, a coprocessor, a controller or various other processing means or devices including integrated circuits such as, for example, an ASIC (application specific integrated circuit), a field programmable gate array (FPGA), and/or the like. In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network.

The user interface 72 may be in communication with the processing element 70 to receive an indication of a user input at the user interface 72 and/or to provide an audible, visual, mechanical, and/or other output to the user. As such, the user interface 72 may include, for example, a keyboard, a mouse, a joystick, a touch screen display, a conventional display, a microphone, a speaker, and/or other input/output mechanisms. In an exemplary embodiment in which the apparatus is embodied as a server, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processing element 70 may be embodied as or otherwise control an active adapter 78. In this regard, for example, the active adapter 78 may be any means or device embodied in hardware, software, or a combination of hardware and software that is configured to perform the corresponding functions of the active adapter 78 as described below. In an exemplary embodiment, the active adapter 78 may be embodied as a native-to-URI mapper, configured to map a generated uniform resource identifier (URI) to corresponding native access parameters for use in enabling, for example, a browser application 80 or web application 82 (e.g., a widget), either of which may be executable by the processing element 70, to access native broadcast signaling via the generated URI without any need for authoring Java or similar code to enable such access. Hereinafter, for the purposes of brevity and example, an embodiment will be described in reference to the browser application 80 (or browser). However, it should be understood that embodiments are equally applicable to utilization with the web application 82.

In an exemplary embodiment, the active adapter 78 may be embodied as a program or daemon that may be running or triggered to run upon invocation from the browser. The active adapter 78 may be configured to interpret and may also perform format translation with respect to native signaling (e.g., native broadcast signaling). In this regard, for example, the active adapter 78 may be configured to enable a browser, for example browser application 80, to access native signaling transmissions by capturing data and forwarding the captured data to the browser in a web/browser supported format. In an exemplary embodiment, an address may be generated by the active adapter 78. The address may be an address that the browser can handle. In other words, the address may be expressed in a format that the browser understands and/or is familiar with such as, for example, a URL or a port identification. Accordingly, a native signaling transmission, which may be considered a stream in an unknown format from the perspective of the browser, may be examined by the active adapter 78 for adaptation into form that the browser can understand. The understandable form may be accessible via the address, which may be associated with native access parameters that may enable the browser to access the native signaling.

In an exemplary embodiment, the address may be a URI such as, for example, special URL-type (e.g., “broadcast:”) that may be used in a hypertext, widget, etc., or a port identifier. The use of the URL-type may resemble a “file:” URL that may give access to a local file system. Upon rendering hypertext associated with the special URL-type, the browser may invoke a plug-in associated with the URL-type. In this regard, the value of the URL itself may be communicated to the plug-in. Meanwhile, as indicated above, the address in an alternative embodiment may be defined as a port identifier such as, for example, a well-known local port (e.g., 9999). Thus, for example, the address may be expressed as http://localhost:9999/. The address may then be appended with a command such as, for example, http://localhost:9999/getPrograms.

The active adapter 78 may be configured to generate the address for association with native access parameters. The native access parameters may enable a format translation with respect to at least portions of the native signaling into a format that the browser can handle. Additionally or alternatively, the native access parameters may be an IP address of an IP based data stream that the browser can handle. The native access parameters, in association with the address, may enable the browser to handle the native signaling and/or access content in a native content stream.

As an example of operation of the active adapter 78, the following scenario is provided. The browser may receive indications of native signaling and invoke a URI request 84 including a particular command such as, for example, a command to show available programs. For example, native signaling transmissions may be received by the processing element 70 (or the browser) via the communication interface 74. An example URI may be “broadcast://getListOfAvailablePrograms” or http://localhost:9999/getListOfAvailablePrograms. The URI request 84 may be communicated to the active adapter 78. The active adapter 78 may, in response to receipt of the URI request 84, interpret the native signaling to compile a list of programs corresponding with the received native signaling. The active adapter 78 may then establish a mapping table 86 containing entries for a corresponding set of native access parameters for each program and a generated address (or URI) associated with each of the sets of native access parameters. In other words, the active adapter 78 (or native-to-URI mapper) may map a URI to corresponding parameters that the browser, and a corresponding media player behind the browser, can understand. The URI or URIs could be mapped in a one-to-one match with a corresponding set of access parameters. However, as an alternative, multiple access parameters may be mapped to a single URI. For example, multiple streams, each of which may correspond to respective native signaling channels, may each be mapped to the same URI.

The URI may include both a hyperlink and associated text (e.g., describing the associated program or including other text) or a link specification to be rendered. In this regard, for example, the link specification (e.g., that which is to be rendered to be indicative of the URI) may be generated to include text that may be descriptive of the URI or the access parameters. As such, for example, the link specification could be a concatenation of the access parameters or even an extracted portion of the corresponding data stream from the native signaling. As an example, the active adapter 78 may take a snapshot of a data stream (e.g., a single frame, an image, etc.), extract a portion of the stream (e.g., a channel logo, live capture, etc.) and/or the like, in order to generate a picture, graphical element and/or animation corresponding to the snapshot or extracted portion of the stream, for use as the link specification. Furthermore, in an exemplary embodiment, the URI may be a video URI (e.g., that may open a video window within the browser) that may point back to the active adapter 78.

After generation of the address in response to the URI request 84 and association of the address with corresponding native access parameters, the active adapter 78 may communicate a listing (which may include one or more URIs) of URI entries 88 (e.g., without the native access parameters) to the browser. The browser (e.g., the browser application 80 or alternatively the web application 82 (e.g., a widget)) may then display or render the URI entries 88, for example, via the user interface 72. The URI entries 88 may each be rendered at the user interface 72 with a corresponding associated text and/or link specification.

In response to a user selection of a particular URI from among the URI entries 88 (e.g., set of links) via the user interface 72, a request may be sent back to the active adapter 78 with respect to the selected URI or link. The active adapter 78 may then utilize the mapping table 86 to access the native broadcast using the corresponding access parameters. In an exemplary embodiment, the active adapter 78 may be further configured to relay, translate, re-encapsulate or otherwise communicate the native broadcast that corresponds to the selected URI to the browser for rendering. Thus, the active adapter 78 may provide a feed to the browser or widget that invoked the initial URI request with data corresponding to that which the user has selected. As such, for example, the active adapter 78 may mimic a normal Internet video server with respect to the browser/widget and act as a native application accessing the native broadcast.

Thus, as indicated above, the active adapter 78 may act as a native-to-URI mapper by generating an address to be associated with corresponding access parameters for a native stream. Accordingly, the active adapter 78 may enable a browser, web application, web page, etc., to handle the address, which may be in a form that may make sense to the browser, web application, web page, etc., and also to the media player that will ultimately render the native stream. As indicated above, the address may provide access to an IP based stream. However, in an alternative embodiment, the active adapter 78 may further be configured to translate the stream itself into a format that the browser can utilize. For example, the active adapter 78 may be configured to receive a native stream and translate the native stream into a different format such as an IP based stream. In any case, embodiments of the present invention may enable the browser, web page, etc., to utilize a normal hypertext representation of web pages and access native signaling without a need for Java or similar interfaces. As such, for example, embodiments may provide service interactivity related to mobile television broadcasts directly using hypertext presentation.

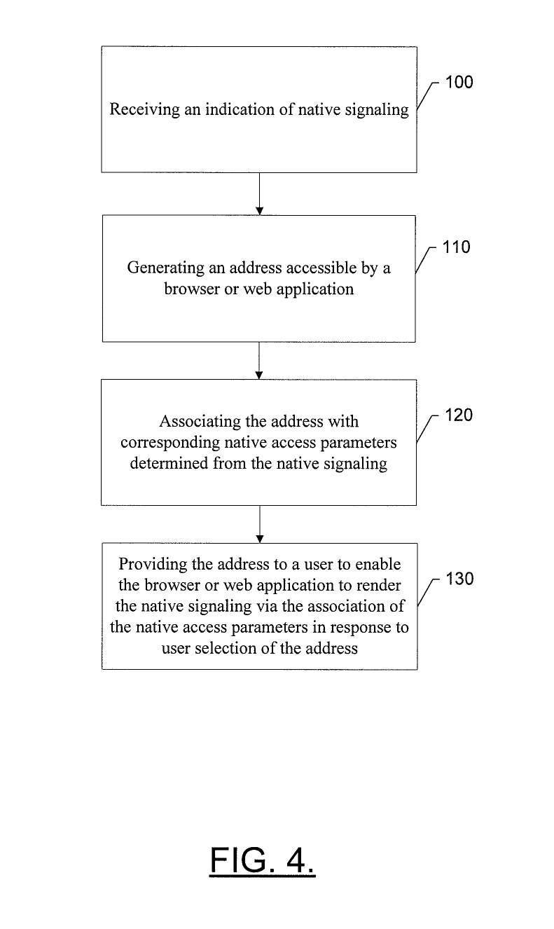

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a built-in processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling the receipt of native broadcast content by browsers or web applications as illustrated, for example, in FIG. 4 may include receiving an indication of native signaling at operation 100. At operation 110, an address accessible by a browser or web application may be generated. The address may then be associated with corresponding native access parameters determined from the native signaling at operation 120. The method may further include providing the address to a user to enable the browser or web application to render the native signaling via the association of the native access parameters in response to user selection of the address at operation 130. In one embodiment, the method may further include translating a native stream associated with the native signaling into a different format for service to the browser or web application. In the context of embodiments of the present invention, the term user above may represent an individual or entity which may provide an automated response and which is acting on behalf of the individual.

In an exemplary embodiment, operation 110 may include generating a uniform resource identifier (URI) that may include a link specification comprising data extracted from content in the native signaling. Furthermore, the link specification may include a graphical element generated based on the extracted data. In some embodiments, associating the address with corresponding native access parameters may include generating a mapping table including a corresponding uniform resource identifier (URI) associated with each of a plurality of sets of access parameters. In some situations, generating the mapping table may include associating more than one set of access parameters with a single URI. In an exemplary embodiment, generating the address may include generating a portion of the address as a concatenation of the access parameters associated therewith. The address generated at operation 110 can be specific to the native signaling. For example, DVB-T, MPEG2-TS, etc., could have an address of one particular type and structure, while MediaFLO could have an address of another type and structure. However, this is not necessary, since all native signaling could result in the same type and structure in some embodiments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of native signaling;
generating an address accessible by a browser or web application;
associating the address with corresponding native access parameters determined from the native signaling; and
providing the address to a user to enable the browser or web application to render the native signaling via the association of the native access parameters in response to user selection of the address.

2. A method according to claim 1, wherein generating an address comprises generating a uniform resource identifier (URI).

3. A method according to claim 2, wherein generating the URI includes generating a link specification comprising data extracted from content in the native signaling.

4. A method according to claim 3, wherein generating the link specification comprises generating a graphical element based on the extracted data for inclusion in the link specification.

5. A method according to claim 1, further comprising translating a native stream associated with the native signaling into a different format for service to the browser or web application.

6. A method according to claim 1, wherein associating the address with corresponding native access parameters comprises generating a mapping table including a corresponding uniform resource identifier (URI) associated with each of a plurality of sets of access parameters.

7. A method according to claim 6, wherein generating the mapping table comprises associating more than one set of access parameters with a single URI.

8. A method according to claim 1, wherein generating the address comprises generating a portion of the address as a concatenation of the access parameters associated therewith.

9. A computer program product comprising at least one computer-readable storage medium having computer-readable program code portions stored therein, the computer-readable program code portions comprising:
a first executable portion for receiving an indication of native signaling;
a second executable portion for generating an address accessible by a browser or web application;
a third executable portion for associating the address with corresponding native access parameters determined from the native signaling; and
a fourth executable portion for providing the address to a user to enable the browser or web application to render the native signaling via the association of the native access parameters in response to user selection of the address.

10. A computer program product according to claim 9, wherein the second executable portion includes instructions for generating a uniform resource identifier (URI).

11. A computer program product according to claim 10, wherein the second executable portion includes instructions for generating a link specification comprising data extracted from content in the native signaling.

12. A computer program product according to claim 11, wherein the second executable portion includes instructions for generating a graphical element based on the extracted data for inclusion in the link specification.

13. A computer program product according to claim 9, further comprising a fifth executable portion for translating a native stream associated with the native signaling into a different format for service to the browser or web application.

14. A computer program product according to claim 9, wherein the third executable portion includes instructions for generating a mapping table including a corresponding uniform resource identifier (URI) associated with each of a plurality of sets of access parameters.

15. A computer program product according to claim 14, wherein the third executable portion includes instructions for associating more than one set of access parameters with a single URI.

16. A computer program product according to claim 9, wherein the second executable portion includes instructions for generating a portion of the address as a concatenation of the access parameters associated therewith.

17. An apparatus comprising an active adapter configured to:
receive an indication of native signaling;
generate an address accessible by a browser or web application;
associate the address with corresponding native access parameters determined from the native signaling; and
provide the address to a user to enable the browser or web application to render the native signaling via the association of the native access parameters in response to user selection of the address.

18. An apparatus according to claim 17, wherein the active adapter is further configured to generate a uniform resource identifier (URI).

19. An apparatus according to claim 18, wherein the active adapter is further configured to generate a link specification comprising data extracted from content in the native signaling.

20. An apparatus according to claim 19, wherein the active adapter is further configured to generate a graphical element based on the extracted data for inclusion in the link specification.

21. An apparatus according to claim 17, wherein the active adapter is further configured to translate a native stream associated with the native signaling into a different format for service to the browser or web application.

22. An apparatus according to claim 17, wherein the active adapter is further configured to generate a mapping table including a corresponding uniform resource identifier (URI) associated with each of a plurality of sets of access parameters.

23. An apparatus according to claim 22, wherein the active adapter is further configured to associate more than one set of access parameters with a single URI.

24. An apparatus according to claim 17, wherein the active adapter is further configured to generate a portion of the address as a concatenation of the access parameters associated therewith.

25. An apparatus comprising:
means for receiving an indication of native signaling;
means for generating an address accessible by a browser or web application;
means for associating the address with corresponding native access parameters determined from the native signaling; and
means for providing the address to a user to enable the browser or web application to render the native signaling via the association of the native access parameters in response to user selection of the address.
